(19) United States
(12) Patent Application Publication
(10) Pub. No.: US 2020/0383436 A1
(43) Pub. Date: Dec. 10, 2020

(54) ARTICLE AND METHOD FOR FORMING STRUCTURES WITH VARIABLE OPTICAL PROPERTIES ON A SHINY SUBSTRATE

(71) Applicant: BANCO DE MÉXICO, Ciudad de México (MX)

(72) Inventors: Fernando CHAPA-NAVA, Ciudad de México (MX); Heinrich Fidencio TERBORG-DEL ROSAL, Ciudad de México (MX)

(73) Assignee: BANCO DE MÉXICO, Ciudad de México (MX)

(21) Appl. No.: 16/463,991

(22) PCT Filed: Nov. 28, 2017
(86) PCT No.: PCT/IB2017/057430

§ 371 Date: May 24, 2019

(30) Foreign Application Priority Data
Nov. 28, 2016 (MX) MX/A/2016/015576

(51) Int. Cl. A44C 21/00; B44C 1/24

(52) U.S. Cl. CPC A44C 21/00; B44C 1/24

(57) ABSTRACT

It describes an article and method for creating a optical effect of moving images, which is produced when the angle of light reflection is changed on surfaces with embossed structures, characterized by: a) providing a metallic substrate with brightness (10); b) embossing on the substrate (10) surface (15) at least a first profile (20) and a second profile (30), which includes at least two reliefs (22, 24, 26), (32, 34, 36) being said second profile (30) adjacent to the first profile (20) and spaced apart from each other at a predetermined distance (40); c) obtaining an image by light reflection produced in the reliefs of the profiles (20 and 30) at an angle of reflection “θ1” which results in a visual view of a first relative distance “X1” between the profiles (20 and 30); d) obtaining a reflection image produced in the reliefs of the profiles (20 and 30) at an angle of reflection “θ2”, resulting in the visual view of a second relative distance “X2” between the profiles (20 and 30), wherein the movement of the embossed structure creates an optical zoom in and out effect between the afore mentioned profiles caused by the distance difference between “X1” and “X2”.

### BACKGROUND OF THE INVENTION

### 1. Field of the Invention

The present invention relates to an article and method for forming images or figures with specific movements, which occur when the angle of reflection of the light and/or the angle of observation on surfaces with embossed structures of bright materials are varied.

### 2. Background of the Invention

In general, items or valuable objects such as coins, banknotes, credit cards, visas, passports, etc.; such articles in which it is sought to protect their authenticity, security and prevent counterfeit, through the time there have been developed different articles, objects and methods of security by means of reflection of light on reliefs in diverse surfaces; This technique is also applied to the field of entertainment with images such as stamps, commemorative coins, cards, ID cards, etc.

Nowadays, there is a great need for methods of reflection of reliefs on various surfaces that are simple, inexpensive, safe and that protect the material as well as making them different and unique.

Historically, methods of reflection of reliefs on surfaces have been developed. Various methods of reflection are known in the prior art, said methods, processes and/or objects are presented as complex arrangements or designs. For example:

The Spanish patent 2 428 141, published on Jun. 26, 2013; describes a “Method for applying an embossed image to a coin/token and the die used for it”. Wherein, the method for providing an image (7) to a coin/token (1), comprises the application of a relief structure consisting essentially of triangular rime (2), wherein part (9) of said image is applied to one side of a rib and a series of said sides of a series of said ribs forms said image (7), wherein said part of said image on said side of said rib is formed by making regions with reflective characteristics in said side, which regions differ from the other regions of said side, characterized in that the provision of said regions with different reflective properties comprises the provision of an raised surface (5) that extends essentially parallel to the remaining surface of said side.

The Spanish patent 2 109 435, published on Feb. 2, 1994; describes an “Anti-counterfeit latent image formation device for bills, credit cards, etc., and method for their manufacture”. Wherein, the device of formation of anti-counterfeit latent images for bills, bank notes, securities, credit cards, passports, valuable documents and the like comprises a main body (4, 5), projections (1a) and depressions (1b), or protuberances (1a′) formed in said main body in such a way as to exhibit different kinds of drawings, wherein said different kinds of drawings comprise straight and/or corrugated image lines (1, 3) forming a drawing (1′), a relief drawing (3′), or a combination of said drawing and said relief drawing, a plurality of straight and/or corrugated printed lines (2) printed on at least one surface of said main body a predetermined intervals, surface which is a surface provided with said projections or depressions, said printed lines being printed straight and/or corrugated (2) in a different color from said main body thereof; said image lines (1, 3) being outside of a defined area (f, f′) substantially parallel to said printed lines (2) and forming said image lines (1, 3) within said defined area, at least in part, an angle with respect to said image lines (1, 3) that lie outside the defined area (f, f′).

The Mexican patent 322 319, granted on Jul. 28, 2014; describes an “object comprising a region of its surface adapted for displaying a plurality of images”. Wherein, the object (1) comprises a region (R) of its surface adapted for displaying a plurality of images in which each image is observable by a user from a different direction, where this flat region (R) comprises: a plurality of cavities (1.1) in bas-relief distributed regularly on the surface of the region (R); each of the cavities (1.1) shows a plurality of side angles (1.1.1, 1.1.2, 1.1.3, 1.1.4), at least one angle per image, where each angle (1.1.1, 1.1.2, 1.1.3, 1.1.4) is associated either to a first level of brightness or to a different brightness level from the first; the angles (1.1.1, 1.1.2, 1.1.3, 1.1.4) that determine an image and are associated with the first level of luminosity have the same orientation and inclination with respect to the surface where the cavity (1.1) is located and, this orientation is different from the orientation of the angles (1.1.1, 1.1.2, 1.1.3, 1.1.4) of another different image.

The European Patent EP 2 554 397 A1, published on Feb. 6, 2013; describes “a structure of relief or enhancement”. Wherein, the relief structure for displaying different images in different viewing directions. The relief structure comprises a plurality of grooves, wherein each groove comprises a first side wall for displaying one line of a first image in a first viewing direction, and a second side wall for viewing a line of a second image in a second viewing direction. The relief structure according to the invention is characterized in that each groove further comprises a lower section for the visualization of a line of a third image in a third direction of vision, and each of the lower section, the first side wall and the second side wall comprises recesses that define the amount of light that is scattered in the respective vision direction corresponding to pixel values of the three images. The invention also relates to a relief structure for viewing four different images in four different viewing directions.

The European patent EP 0 194 042 A2, published on Sep. 10, 1986; describes a substrate, (1), for example, of thermoplastic material or paper, has been embossed with respect to the first (2a) and second relief elements (2b) without reflection light, defining first and second patterns, respectively. The modeling area (stamping) is uniformly reflective. For example, the first raised elements (2a) form a bottom area in which the second elements (2b) are arranged in the form of a company logo. The first (2a) and the second (2b) relief elements are so structured that when the viewing direction of the same is changed from a first to a second direction, the perceived distinction connection of the first and second patterns is changed. The substrate can be part of a security document whose authenticity can be verified by ensuring that the relative distinction of the two patterns changes with the viewing angle.

The European patent EP 0 537 439 B1 published on Apr. 24, 1993 describes “a process for the production of a security element on a carrier material (or support) (17) made of plastic material, with elements of reflection in relief (4, 4′) comprising microscopic relief structures (12) and with neutral zones (5) between the reflection elements (4, 4′), characterized in that a relief embossing die (36) with raised structures (37) are used to enhance the carrier or support material (17), that the neutral areas (5) without relief are covered with a separation layer (25) comprising a washable material, and that the relief structures (12) and the surfaces of the separation layer (25) together with the reflective layer (14) in the neutral zones (5) are removed and that a protective layer (13) is applied over the entire surface of the carrier material or support (17)”.

Therefore, there is still a need to improve articles, objects and technique of methods to create an optical effect of images or figures with pre-established movements which occur when the angle of reflection of light on a surface with reflective properties is varied, wherein said surface has specific reliefs and/or valleys and wherein said specific reliefs and/or valleys are on surfaces of bright or reflective materials.

### SUMMARY OF THE INVENTION

One of the purposes of the present invention is to provide an article with images or figures with specific apparent motion, which occur when the angle of reflection of the light and/or the angle of observation on surfaces with embossed structures (low and high relief) of bright materials are varied.

Another aspect of the present invention is to provide a method for forming images or figures with specific apparent motion, which occur when the angle of reflection of light is varied on surfaces with embossed (low and high relief) structures of bright materials and where the brighter the surface of said bright material, the greater and better the optical effect of the movement.

It is yet another aspect of the present invention to provide a structure with an embossed (low and high relief) profile so that the images or figures produce the optical effect of specific movement.

These and other objects of the present invention are achieved by providing an article and a method for creating an optical effect of moving images, which occurs when the angle of reflection of the light on surfaces with embossed (low and high relief) structures is varied, characterized in comprising: (a) providing a substrate 10 having a metallic brightness; (b) embossing on the surface 15 of the substrate 10 at least a first profile 20 and a second profile 30, having at least two reliefs (22, 24, 26), (32, 34, 36), said second profile 30 being adjacent to said first profile 20, and separated by a distance 40; (c) obtaining an image by the reflection of the light produced in the reliefs of the profiles 20 and 30, at a reflection angle “θ1”, which results in the appreciation of a first relative distance “X1” between the profiles 20 and 30; and (d) obtaining an image by reflection of the light produced in the reliefs of the profiles 20 and 30, at a reflection angle “θ2”, which results in the appreciation of a second relative distance “X2” between profiles 20 and 30; wherein the apparent movement of the structure embossed from the reflection angle of “θ1” to the reflection angle of “θ2” create an optical approach-distance effect between said profiles, by the difference of distances between “X1” and “X2”.

### BRIEF DESCRIPTION OF THE DRAWINGS

The present invention will be fully understood by the detailed description given hereinafter and in the accompanying drawings, which are given by way of illustration and example only and are therefore not limited regarding the aspects of the present invention. In the drawings, the identical reference numbers identify similar elements or actions. The relative sizes and positions of the elements in the drawings are not necessarily drawn to scale. For example, the shapes of the various elements and angles are not drawn to scale, and some of these elements are enlarged and placed arbitrarily to improve the understanding of the drawing.

Additionally, the particular shapes of the elements as drawn, do not intend to transmit any information regarding the actual shape of the particular elements and have only been selected to facilitate their recognition in the drawings, wherein:

FIG. 1 illustrates a right side view of an article exhibiting relief to create the effect of apparent relative motion between two points on a bright surface.

FIG. 2 illustrates the tangential or normal lines of the reliefs of an article that exhibits the effect of relative motion between two points.

FIG. 3 illustrates a right side view of the effect of relative motion between the two-point reliefs on a bright surface from a reflection angle of “θ1” with a relative distance named “X1”.

FIG. 4 illustrates a right side view of the effect of relative motion between the two-point reliefs on a bright surface from a reflection angle of “θ2” with a relative distance named “X2”.

FIG. 5 illustrates a top view of the bright surface where the light source is on the left side giving an effect in which the figures “A” and “B” are together.

FIG. 6 illustrates a top view of the bright surface where the light source is on the right side yielding an effect in which the figures “A” and “B” are far apart.

FIG. 7 illustrates a right side view of the incidence of the light source and the observer in a horizontal plane.

FIG. 8 illustrates a right side view of the incidence of the light source and the observer in an inclined plane.

FIG. 9 illustrates a graph with an example of the desired trajectory of the observed light in relation to the position and increase in the angle of inclination.

FIG. 10 illustrates a graph of the desired trajectories of the observed light in relation to the position and increase of the angle of inclination, in an inverse function.

FIG. 11 illustrates a graph of the expected movements for two trajectories of light, in relation to the position and increase of the angle of inclination.

FIG. 12 illustrates graphically the automatic generation of the tied profile (P₁, P₂) that generates the light trajectories exemplified in FIG. 11.

FIGS. 13 A, 13 B and 13 C illustrate an application method for simulating a change of separation between two lines in accordance with the present invention.

### DETAILED DESCRIPTION OF THE INVENTION

Various aspects of the present invention are described below in more detail, with reference to the accompanying drawings, in which variations and aspects of the present invention are shown. Several examples of aspects of the present invention can, however, be realized in many different ways and should not be construed as limitations to the variations set forth in the present invention, on the contrary, variations are provided so that this description is complete in the illustrative implementations, and the scope thereof is completely transmitted to those skilled in the art.

Unless otherwise defined, all technical and scientific terms used in this document have the same meaning as commonly understood by one expert in the art to which aspects of the present invention pertain. The methods, processes, systems, circuits and examples provided in this document are illustrative only and are not intended to be limiting.

In contrast with the teachings disclosed in the prior art, this invention contemplates.

An article and method of forming images or figures with specific apparent motion, which occur when the angle of incidence of the light is varied and/or when the angle of observation varies on surfaces with embossed structures of bright materials and where the brighter the surface of said bright material, the greater and better the optical effect of the movement.

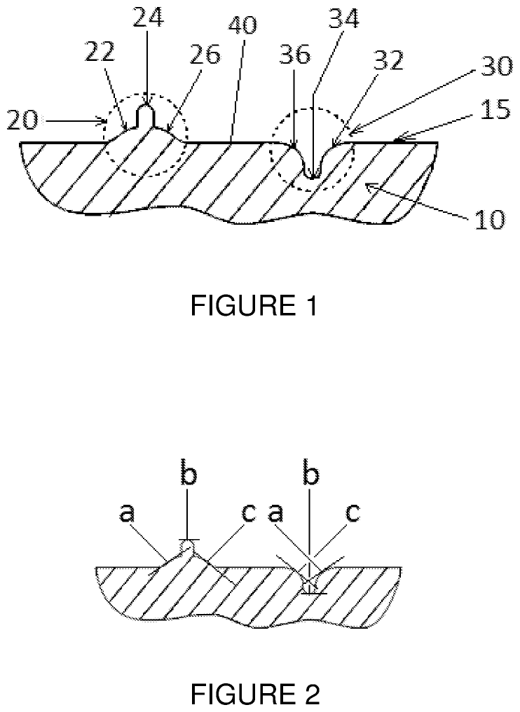

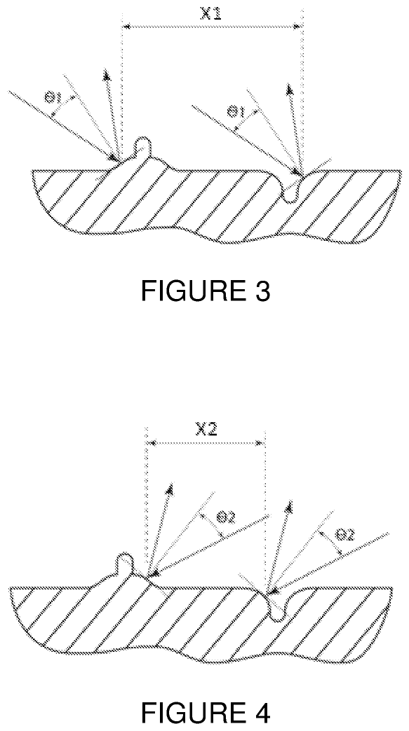

In FIGS. 1, 2, 3 and 4 different perspectives of the bright surface of the article of formation of images or figures with specific movements can be observed, which is formed of profiles of embossing that include points with reliefs, where the distribution and location of the points with reliefs create an apparent motion in the images or figures.

In accordance with the present invention, at least two profiles 20 and 30, which are substantially parallel to one another, are embossed or punched on a surface. In FIG. 1 a cross section of said profiles is shown. As shown in FIG. 1, the first profile 20 consists of a protrusion, i.e. a material protruding from the surface 15 of the substrate 10 while the second profile 30 consists of a slit or channel immersed in the substrate 10.

The first profile 20 includes a plurality of reliefs having surfaces with a certain orientation, which in turn defines as an angle of reflection of the light. In FIG. 1, reliefs 22 (first relief), 24 (second relief) and 26 (third relief) for the first profile 20 and the respective reliefs 32 (first relief), 34 (second relief) and 36 (third relief) for the second profile 30, are noticed in particular. According to the present invention, FIGS. 1 and 2, it is provided that in a first position (a), a user can notice the reflection of the light of the reliefs (first) 22 and 32, while the other surfaces are not perceptible or only slightly noticeable. In a second position (b) the second relieves 24 and 34 are discernible, and in a third position (c) the third reliefs 26 and 36 are perceptible. As will be apparent to a person skilled in the art, an article may have more than two pairs of profiles (20, 30) and more than two reliefs of each profile (20, 30).

When the light is reflected over the entire surface the effects of brilliance that occur in the reliefs of these two points to an optical effect is generated, which results in a first relative distance between these points named “X1”. By varying the angle of reflection to “θ2” the optical effect due to reflection of the light that is generated is a new (second) relative distance between these two points named “X2”.

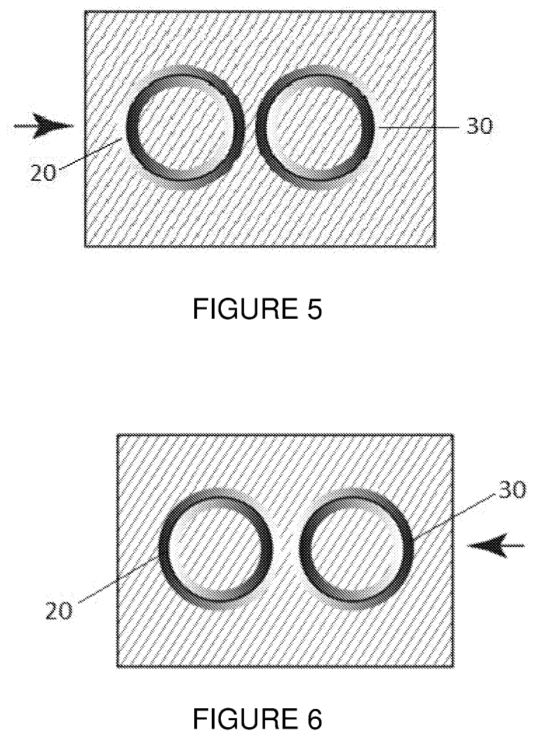

When these two points are observed from the first reflection angle of “θ1” to the second reflection angle of “θ2”, the optical effect of relative motion between these points is created, causing an approaching or distancing effect represented by the difference of distances between “X1” and “X2” (see FIGS. 5 and 6). In FIG. 5, for example, the hoops appear to be closer compared to FIG. 6 where the hoops appear to be further apart.

When figures are created by combining these reliefs they result in an optical effect in which said figures approach or separate from each other, generating the effect of relative motion between them, that is, if one figure has “A” type relief and another figure has relief type B″; When observing said figures on a bright surface when the light is reflected on them and modifying the angle of reflection it will be seen as if both figures approach or move away from each other.

The approach effect between figures “A” and “B” is achieved by placing the light source on the left side of the bright surface. While the distance effect between figures “A” and “B” is achieved, placing the light source on the right side of the bright surface.

The method for producing the glossy surface includes obtaining embossed structures and obtaining the relief profile of embossed structures, where the profiles of the relief are different from each other.

### Computational Method for Calculating the Profile of the Reflecting Surface Based on the Desired Movement of a Point of Light.

Considerations:
First, the one-dimensional case is treated since it can easily be extrapolated to 2D or circular symmetries (polar coordinates).
By one-dimensional it is understood that the profile of the substrate along the direction of “movement” x (11) will be replicated for a zone of width Δy orthogonal to the X axis (12). This is that when referring to a “point of light” it can refer to an area (area) of light.
The profile must be one-valued with respect to x (11) so that it can be stamped or embossed in the normal direction to x (12).

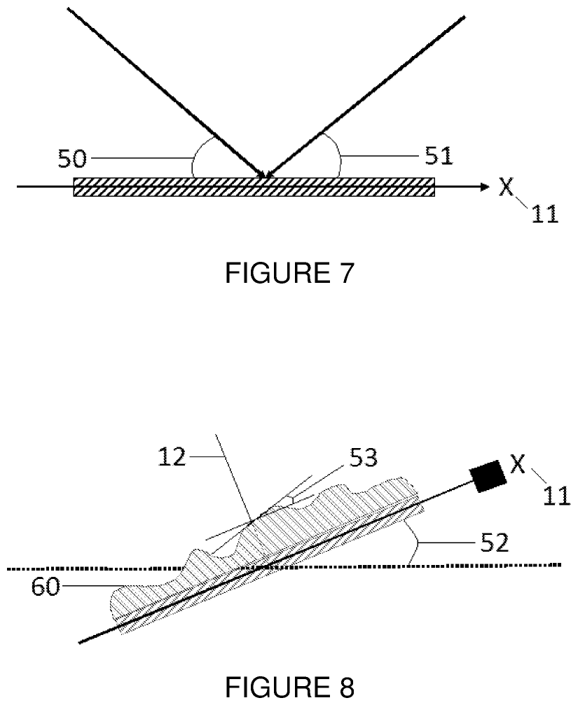

In FIG. 7 it is illustrated how the observer looks at point x with an angle θ_{obs} 51 and the same point x is illuminated by a ray of light incident with angle θ_{luz} 50.

FIG. 8 illustrates the approach to the substrate to show the profile P(x) 60, that is, the normal height at the base of the substrate at the position x, σ(x) 53 is the local angle of the line tangent to the profile at the position x, and φ 52 refers to the inclination caused to the substrate to show the effect of movement. It is important to note that although φ changes, the angles of the observer θ_{obs} and illumination θ_{luz} on the point x, do not change.

The trajectory (of the desired movement) is defined as x(φ) 70 which is the path of a point of light that one wishes to observe when the substrate is inclined in a range of values of φ:

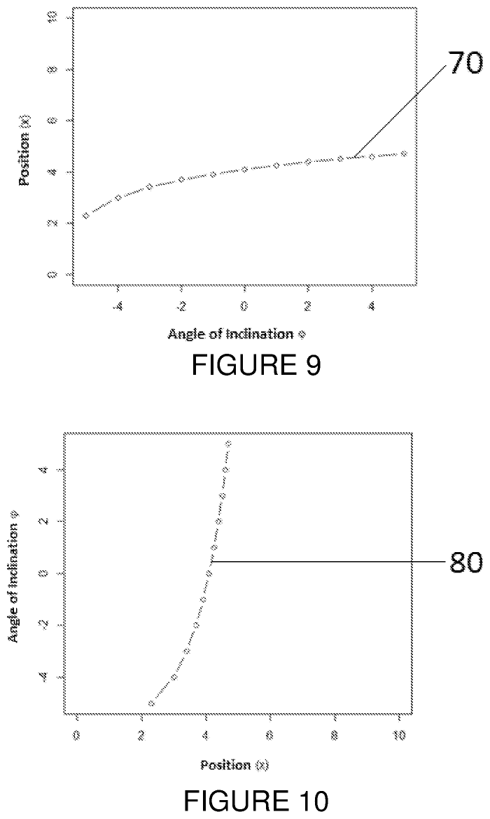

The FIG. 9 illustrates graphically an example of the definition of a movement of the point of light when tilting the substrate. x≡x(φ).

Therefore the condition that has to be met so that the observer can see a point of light in the position x when the substrate has an inclination φ 52 is:

$$σ ( x ) = \frac{{θ}_{obs} - {θ}_{lux}}{2} - ϕ$$

Where σ(x) is the local angle 53 that the line tangent to the profile P(x) 60 must have at the position x. This means that:

$$\frac{dP ( x )}{dx} = tan ( σ ( x ) )$$

At this point it is convenient to consider that we have defined the position of the luminous point as a function of the angle of inclination x≡x (φ) 70, and because it is a single-valued function (there can not be two different profile heights for the same position x) we can say that φ≡φ (x) 80. In this way:

$$P ( x ) = \int tan ( \frac{{θ}_{obs} - {θ}_{lux}}{2} - ϕ ( x ) ) dx + cte . \qquad ( Equation of relief )$$

The integral is over the range of values of x where the trajectory is defined.

By this equation we have a method to obtain the relief (i.e., raised structures and “low relief”) 60 that the substrate 10 must have to show the predefined movement: position (x) vs angle (φ).

In relation to the previous equation, it is important to consider the following characteristics:
This equation can be used to treat a plurality of light points as long as their positions do not intersect.
To allow non-uniform light sources, the lighting profile is defined by θ_{luz}≡θ_{luz}(x,φ(x)).
For the case in which the substrate is very large in relation to the observation distance, the observation profile is defined by θ_{obs}≡θ_{obs}(x,φ(x)).
It is possible to generate different effects on the same surface x, and through and/or P_{y=cte}(x)/y/o P_{x=cte}(y).
It is possible to use other types of coordinates, for example polar (r, θ), when defining a movement along the radius (r) as a function of the angle of rotation (θ).

### Method A. Application to Simulate a Change of Separation Between Two Points of Light

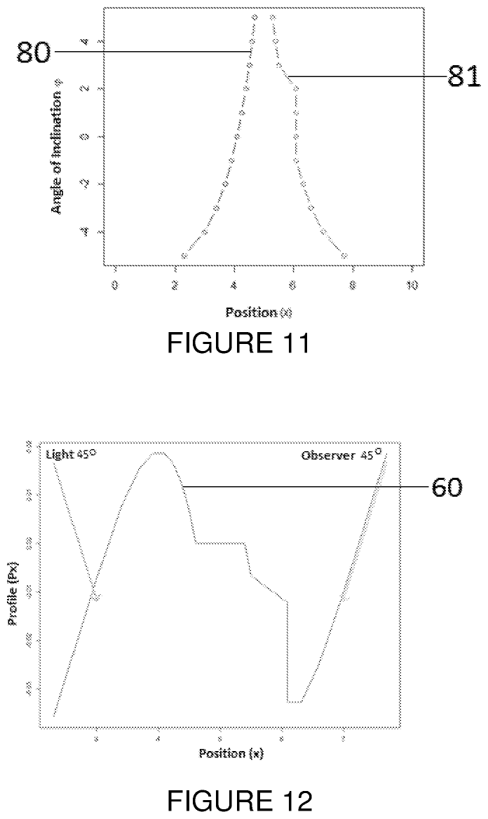

FIG. 11 graphically illustrates how the expected movements are defined for each of the points x_1 (φ) 80 and x_2 (φ) 81, wherein:
1. Define the trajectories that the luminous points must follow as a function of the angle of inclination of the substrate x1(φ), x2(φ)
2. The observation parameters y θ_{obs} are defined, either constants or functions for both points.
3. The profiles P₁, P₂ are calculated for each of the trajectories x₁, x₂ using the equation of the profile.
4. In FIG. 12 you can see the graph of the tie of the profiles P₁, P₂ according to their domain of action in x to obtain normal height to the base of the substrate in the position x, P(x) 60.
5. In the case that it is required to work in a range of observation parameters, steps 2 to 4 are performed to obtain a series of profiles {P} from which a consensus profile \hat{P} can be obtained to be embossed considering tolerances in follow-up of the trajectory.

### Example

The FIG. 11 exemplifies possible movements expected for two luminous points x_1 (φ) 80 and x_2 (φ) 81, wherein, by way of example, the apparent distance between said points will decrease as the angle of inclination increases φ.

According to Method A, the observation parameters θ_{luz} and θ_{obs}, are defined that by way of example in FIG. 12 both are equal to 45°.

The profiles are then calculated P₁, P₂ for each of the trajectories according to the method A step 3 and they are joined to obtain P(x) 60 in FIG. 12.

In this way when embossing the profile P(x) 60 in a bright material, it will exhibit the apparent motion effect 80 and 81 between two light zones by changing the angle of inclination 52.

### Application Method to Simulate a Change of Separation Between Two Light Lines

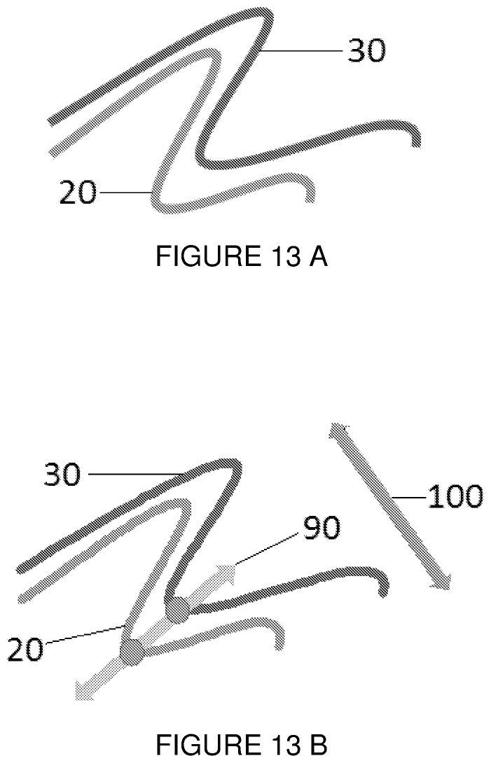

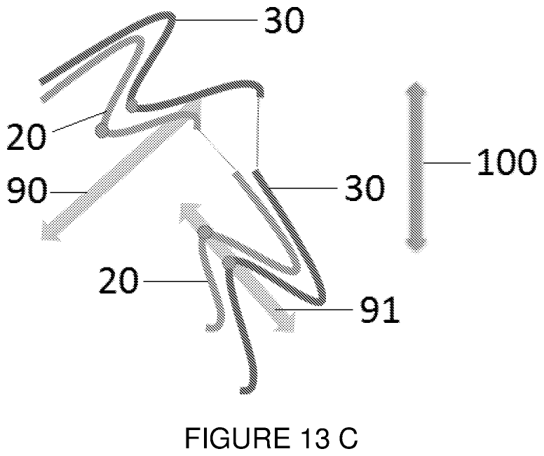

Two profiles 20 and 30 are defined (see FIG. 13 A) illustrated as lines. The direction of movement 90 and the direction of inclination φ 100 are defined (see FIG. 13 B). The distance between two points in the lines along the direction of movement is used to define the trajectories of method A (step 1). The profile obtained by means of method A should be embossed along the lines using the direction defined as direction of movement as the x axis. It is clear to a person with average knowledge in the field that different directions of movement 90,91 can be defined along different line types (see FIG. 13 C).

In one embodiment of the invention the material of the article is a metal exhibiting a metallic brightness, for example gold, silver, nickel, zinc, copper, bronze or brass. It is also possible to use a polymeric substrate with a surface coating or bath of gold, silver, nickel, zinc, lead, copper, bronze or brass.

Being the invention thus described, it will be obvious that it can be varied in many ways. Such variations should not be considered to depart from the spirit and scope of the invention, and all of these modifications, as would be obvious to those skilled in the art, are included within the scope of the following claims.

The description of the invention is given by way of example only and is not intended in any way to limit the scope of the invention. The above description is provided to enable any person skilled in the art to practice the various embodiments described herein. Various modifications to these embodiments will be readily apparent to those experts in the art, and the generic principles defined herein may be applied to other embodiments. Therefore, the claims are not intended to be limited to the embodiments shown herein, but rather to be granted the full scope consistent with those of the language of the claims, wherein the reference to a singular element is not intended to mean “one and only one”, unless specifically said, but rather “one or more”. All structural and functional equivalents of the elements of the various embodiments described throughout this description, which are known or which will be known later by those expert in the art, are expressly incorporated herein by reference, and are intended to be encompassed by the claims. Therefore, it should be understood that numerous and varied modifications can be made without departing from the spirit of the present invention.
10 substrate,
15 surface of the article,
20 first profile,
22 first relief of the first profile,
24 second relief of the first profile,
26 third relief of the first profile,
30 second profile,
32 first relief of the second profile,
34 second relief of the second profile,
36 third relief of the second profile,
40 separation distance between the first and the second profile,
θ1 first angle of reflection,
θ2 second angle of reflection,
X1 first relative distance,
X2 second relative distance,
x direction of movement,
y orthogonal direction to “x”,
P(x) profile defined as normal height to the base of the substrate at position x,
50, θ_{luz} Angle of light incidence,
51, θ_{obs} Angle of the observer,
52, φ inclination caused to the substrate to show the effect of movement,
53, σ(x) local angle of the tangent line to the profile at position x,
53, σ(x) local angle that the relief P (x) must have at position x,
60, P(x) normal height to the base of the substrate at position x,
70, x(φ) trajectory of the movement that a point of light must follow when the substrate is inclined in a range of values of φ,
90 direction of movement,
100 direction of inclination φ to movement 90,
53, a(x) local angle that the relief P (x) must have at position x,
80 point x_1 (φ),
81 point x_2 (φ), and
90, 91 directions of movement.

1. An image forming element with predetermined movements, comprising:
a profile embossed on a surface of the element comprising at least two profiles, each with at least two reliefs located on the surface of the element; so that only one of the reliefs of each profile reflects light at a certain angle of reflection.

2. The image forming element with predetermined movements according to claim 1, wherein an approach effect of the profiles is apparent when light is reflected in a reflection angle “θ1”.

3. The image forming element with predetermined movements according to claim 1, wherein an effect of distancing of the profiles is apparent when light is reflected in an angle of reflection “θ2”.

4. The image forming element with predetermined movements according to claim 1, characterized in that a profile P(x) that the substrate must have to show predefined movement: position (x) vs angle (φ) is defined according to the equation:
$$P ( x ) = \int tan ( \frac{{θ}_{obs} - {θ}_{lux}}{2} - ϕ ( x ) ) dx + cte .$$
wherein:
the integral is over the range of values of x where the trajectory is defined.
x is the direction of the movement,
θ_{luz} is the angle of incidence of light,
θ_{obs} is the angle of the observer, and
φ is the inclination caused to the substrate to show the effect of movement.

5. The image forming element with predetermined movements according to claim 1, characterized in that the substrate is selected from a metal exhibiting a metallic brightness or a polymeric material having a coating or bath of a metal exhibiting a metallic brightness.

6. The image forming element with predetermined movements according to claim 5, characterized in that the metal exhibiting a metallic gloss is selected from gold, silver, nickel, zinc, lead, copper, bronze or brass.

7. The image forming element with predetermined movements according to claim 5, characterized in that the substrate is a coin.

8. A method for generating reliefs that cause the formation of images with predetermined movements, which occur when the angle of reflection of a light on surfaces with embossed structures is varied, characterized in that it comprises:
providing a substrate having a metallic brightness;
embossing on a surface of the substrate at least a first profile and a second profile, having at least two reliefs, said second profile being adjacent to said first profile, and separated by a distance;
obtaining an image by reflection of the light produced in the reliefs of the profiles, at a reflection angle “θ1”, which results in the appreciation of a first relative distance “X1” between the profiles;
obtaining an image by the reflection of the light produced in the reliefs of the profiles, at a reflection angle “θ2”, which results in the appreciation of a second relative distance “X2” between the profiles; and
where movement of the structure embossed from the reflection angle of “θ1” to the reflection angle of “θ2” create an optical approach-distance effect between said profiles, by the difference of distances between “X1” and “X2”.

9. The method according to claim 8, characterized in that the profile P(x) of the substrate to show the predefined movement: position (x) vs angle (φ) is defined according to the equation:
$$P ( x ) = \int tan ( \frac{{θ}_{obs} - {θ}_{lux}}{2} - ϕ ( x ) ) dx + cte .$$
wherein:
the integral is over the range of values of x where the trajectory is defined.
x is the direction of the movement,
θ_{luz} is the angle of incidence of light,
θobs is the angle of the observer, and
φ is the inclination caused to the substrate to show the effect of movement.

10. The method according to claim 8, characterized in that the substrate is a coin.
